(19) United States
(12) Patent Application Publication
(10) Pub. No.: US 2017/0274694 A1
(43) Pub. Date: Sep. 28, 2017

(54) PRINTABLE FABRIC

(71) Applicant: SAINT-GOBAIN PERFORMANCE PLASTICS CORPORATION, Solon, OH (US)

(72) Inventors: Joseph G. SARGENT, Lowell, MA (US); James M. McMARTIN, Hooksett, NH (US); Peter A. Kirk, Goffstown, NH (US); Michael P. CUSHMAN, Williamstown, MA (US); Gerard T. BUSS, Bedford, NH (US)

(21) Appl. No.: 15/468,555

(22) Filed: Mar. 24, 2017

Related U.S. Application Data
(60) Provisional application No. 62/313,004, filed on Mar. 24, 2016.

(30) Foreign Application Priority Data
Dec. 27, 2016 (JP) 2016-253746

(51) Int. Cl. B41M 7/00; B41F 17/38; B41M 5/50

(52) U.S. Cl. CPC B41M 7/009; B41M 5/504; B41F 17/38

(57) ABSTRACT

A fabric includes a reinforcement material and a layer disposed adjacent to the reinforcement material including a fluoropolymer and an elastomer. The fabric can be an architectural fabric included in an architectural assembly.

### CROSS-REFERENCE TO RELATED APPLICATION

This Application claims priority under 35 U.S.C. §119 to Japanese Application No. 2016-253746, entitled “PRINTABLE FABRIC,” by Joseph G. SARGENT et al., filed Dec. 27, 2016, and claims priority under 35 U.S.C. §119(e) to U.S. Provisional Application No. 62/313,004, entitled “PRINTABLE FABRIC,” by Joseph G. SARGENT et al., filed Mar. 24, 2016, of which both applications are assigned to the current assignee hereof and are incorporated herein by reference in their entireties.

### FIELD OF THE DISCLOSURE

The present disclosure relates to membranes having an ink-receptive layer, and more particularly to such membranes including a coated fabric.

### RELATED ART

Certain existing coated fabrics can be printed on with inks and used for interior architectural membranes. However, due to increasingly stricter building codes and materials available, the membranes are typically limited to single uniform color and fabrication of these membranes can require high temperatures which can be detrimental to standard inks. Accordingly, there exists a need for improved interior architectural membranes.

### BRIEF DESCRIPTION OF THE DRAWINGS

Embodiments are illustrated by way of example and are not limited in the accompanying figures.

FIG. 1 includes a cross-sectional illustration of a membrane according to an embodiment described herein.

FIG. 2 includes a cross-sectional illustration of another membrane according to an embodiment described herein.

FIG. 3 includes a cross-sectional illustration of yet another membrane according to an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fluoropolymer-containing fabric arts.

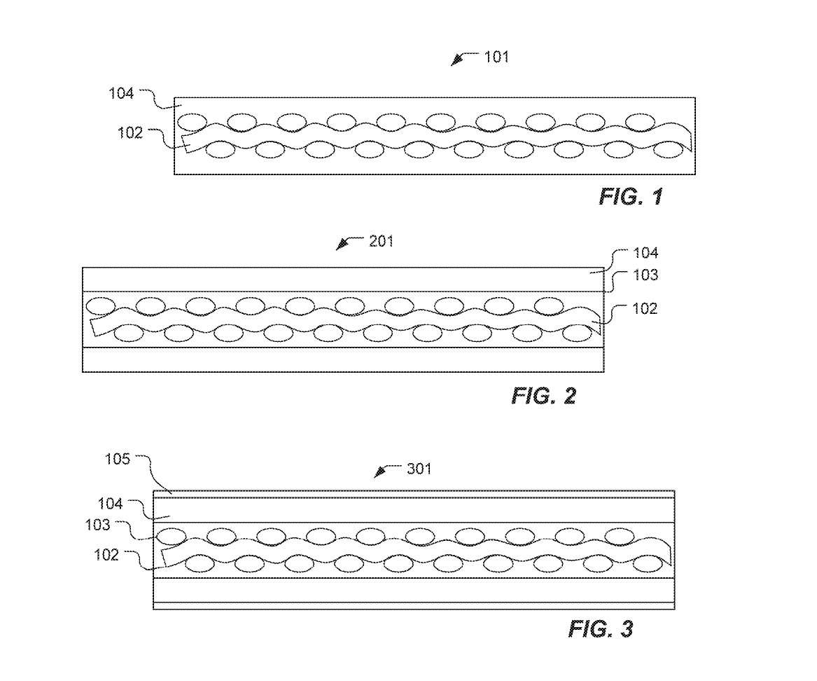

As illustrated in FIG. 1, a membrane 101 can include at least a reinforcement layer 102 and an ink-receptive layer 104 overlying the reinforcement layer 102. As illustrated in FIG. 2, a membrane 201 can further include an intermediate layer 103 disposed between the reinforcement layer 102 and the ink-receptive layer 104. As illustrated in FIG. 3, a membrane 301 can further include a printed layer 105 overlying the ink-receptive layer 104, regardless of the presence of the intermediate layer 103.

In certain embodiments, the ink-receptive layer can include a low-melt material. As used herein, the term “low-melt” refers to a material having a melting temperature of no greater than 200° C. according to ASTM D4591-07(2012). In certain embodiments, the low-melt material can have a melting temperature of no greater than 195° C., or no greater than 190° C., or no greater than 185° C., or even no greater than 180° C. In other embodiments, the low-melt material can have a melting temperature of at least 80° C., or at least 85° C., or at least 90° C., or at least 95° C., or even at least 100° C. Moreover, the low-melt material can have a melting temperature within a range of any of the above minimum and maximum values, such as 80 to 200° C., or 85 to 195° C., or 90 to 190° C., or 95 to 185° C., or even 100 to 180° C.

In certain embodiments, the low-melt material can include a low-melt polymer. In particular embodiments, the low-melt polymer can include a thermoplastic polymer. In more particular embodiments, the low-melt polymer can include a fluoropolymer. For example, the low-melt polymer can include a tetrafluoroethylene-co-hexafluoropropylene-co-vinylidene fluoride terpolymer (hereinafter “THV”), a terpolymer of ethylene, tetrafluoroethylene, and hexafluoropropylene (hereinafter “EFEP”), a polyvinylidene difluoride (hereinafter “PVDF”), or any combination thereof.

In certain embodiments, the low-melt material can include a blend of polymers including the low-melt polymer and an additional polymer. The additional polymer can include a low-melt polymer or a polymer that is not a low melt-polymer, so long as the material forming the ink-receptive layer is still a low-melt material as defined above. For example, the additional polymer can include any of the low-melt polymers listed above, a polytetrafluoroethylene (hereinafter “PTFE”), a perfluoroalkylvinyl ether (hereinafter “PFA”), a polyhexafluoropropylene (hereinafter “HFP”), a fluorinated ethylene-propylene copolymer (hereinafter “FEP”), an ethylene tetrafluoroethylene copolymer (hereinafter “ETFE”), a polychlorotrifluoroethylene (hereinafter “PCTFE”), a perfluoropropylene-vinyl-ether (hereinafter “PPVE”), a copolymer of PTFE and PPVE (hereinafter “TFM”), or any combination thereof.

As discussed above, the ink-receptive layer can be disposed over a reinforcement layer. The reinforcement layer can include a fibrous reinforcement, such as a woven or nonwoven fibrous reinforcement. For example, the fibrous reinforcement can be a woven fabric or an intermeshing of random fibrous strands. In other embodiments, reinforcement layer can include woven and non-woven materials formed of fibers selected from aramid, fluorinated polymer, fiberglass, graphite, polyimide, polyphenylene sulfide, polyketones, polyesters, or a combination thereof. In certain embodiments, the reinforcement layer can include a woven glass fabric. In particular, the reinforcement layer can include a woven glass fabric that has been cleaned or pretreated with heat. Alternatively, the woven glass fabric can be coated. For example, each of the fibers of the woven glass fabric can be individually coated with a polymeric coating, such as a fluoropolymer coating, for example, PTFE. In an embodiment, the fabric can be a plain weave fabric where the warp and fill yarns cross over and under one another. The plain weave fabric can be a glass fabric adapted to improve acoustic properties.

In other embodiments, the reinforcement layer can include a mesh of ceramic, plastic, or metallic material or sheets of composite materials, among others. In still other embodiments, the reinforcement layer can take the form of a substrate, typically a sheet. Embodiments can use supports formed of high melting point thermoplastics, such as thermoplastic polyimides, polyether-ether ketones, polyaryl ketones, polyphenylene sulfide, and polyetherimides; thermosetting plastics, particularly of the high temperature capable thermosetting resins, such as polyimides; coated or laminated textiles based on the above thermoplastics or similar thermally stable resins and thermally stable reinforcements such as fiberglass, graphite, and polyaramid; plastic coated metal foil; and metallized or metal foil laminated plastic films.

To form the ink-receptive layer on the reinforcement material, a low-melt dispersion can be prepared including a precursor to the low-melt material. In certain embodiments, the low-melt dispersion can be an aqueous dispersion. The reinforcement layer can be coated with the low-melt dispersion through a coating process, such as a dip coating process, a knife coating process, a casting process, and the like. Excess material can be wiped and the coating dried and sintered or fused.

In certain embodiments, the reinforcement layer can be passed through an emulsion of the low-melt precursor and a silicone oil as a first pass. The silicone oil can include, for example, a siloxane, such as a methyl phenyl polysiloxane. In particular embodiments, the silicone oil can provide improved coating adhesion and weatherability. In other embodiments, the emulsion is not used and the reinforcement material is passed through the low-melt dispersion for the first pass. Either way, the reinforcement material can be passed through the low-melt dispersion for the second pass, a third pass, a fourth pass, and so on as necessary to achieve the desired thickness. After each pass, the coated material can be passed through a wiping arrangement to remove excess dispersion. The wiping arrangement can include a metering bar, a Bird bar, a wire-wound metering bar, a K bar, or other similar equipment or combinations thereof. Then, the coated material can be heated to dry the dispersion and remove surfactants or other additives. Further, the coated material can pass through a cooling plenum from which it can be directed to a subsequent dip pan to begin formation of a further layer of film, to a stripping apparatus, or to a roll for storage.

Although the membrane described herein can include a reinforcement layer, in certain embodiments, the membrane can be free from a reinforcement layer. Such a membrane can be made using the coating process described above except that the dispersion is coated onto a carrier instead of the reinforcement layer. For example, the carrier can be a solid material that can be separable from the sheet material. In such a case, the membrane including the ink-receptive layer can be formed by first coating the carrier, drying and sintering to form the low-melt material, and ultimately separating the ink-receptive layer from the carrier.

In certain embodiments, the ink-receptive layer can have a thickness of at least 0.005 mm, or at least 0.02 mm, or at least 0.03 mm, or at least 0.04 mm, or even at least 0.05 mm. In further embodiments, the ink-receptive layer can have a thickness of no greater than 1 mm, or no greater than 0.8 mm, or no greater than 0.6 mm, or no greater than 0.4 mm, or no greater than 0.2 mm, or even no greater than 0.1 mm. Moreover, the ink-receptive layer can have a thickness in range of any of the above minimum and maximum values, such as 0.005 to 1 mm, or 0.03 to 0.6 mm, or even 0.05 to 0.1 mm.

In certain embodiments, the membrane can have a coating adhesion of at least 10 pli, or at least 12 pli, or at least 14 pli, or at least 16 pli, as measured according to the standard T-Peel test of ASTM D751-06, using a 3 mil THV film as glue line. Although increased coating adhesion is desirable, in certain embodiments, the membrane may have a coating adhesion of no greater than 30 pli, or no greater than 28 pli, or no greater than 26 pli, or no greater than 24 pli, or no greater than 22 pli, or even no greater than 20 pli. Moreover, the coating adhesion can be in a range of any of the above minimum and maximum values, such as 10 to 30 pli, or 14 to 22 pli, or even 16 to 20 pli.

In certain embodiments, an outer surface of the ink-receptive layer can include a treatment for receiving a printed layer. (The printed layer will be discussed in more detail later in the specification.) As used in the context of the ink-receptive layer, the term “outer surface” refers to the major surface of the ink-receptive layer furthest from the reinforcement layer. In particular embodiments, the treatment can improve adhesion between the ink-receptive layer and the printed layer. For example, the treatment can include a corona treatment, a C-treatment, an ultraviolet treatment, an electron beam treatment, a flame treatment, a scuffing treatment, a sodium naphthalene treatment, or any combination thereof.

In particular embodiments, the treatment can include a Corona treatment. The corona treatment can include exposing the surface of the membrane to corona discharge. The corona discharge can include an ionization of a gas due to the electric field from a nearby conductor. Exposure to the corona discharge can modify the surface layer to increase wettability, cementability, or both. In an embodiment, the effects of a corona treatment can be relatively short, such as on the order of hours. By contrast, in certain embodiments, the surface treatment can include a C-treatment, which includes a high energy treatment carried out in an organic gas atmosphere comprising acteone or an alcohol of four carbon atoms or less, whereas a corona treatment is carried out in a standard atmosphere. In more particular embodiments, organic gas atmosphere of the C-treatment can include acetone. Further, the organic gas atmosphere of the C-treatment can be admixed with an inert gas such as nitrogen. The acetone/nitrogen atmosphere can cause an increase of adhesion as compared to using the acetone atmosphere alone. The C-treatment can create a different chemical species on the surface of the material that increases wettability and cementability as the corona treatment does, while having a much greater lifespan, upwards of several years. In addition, the C-treatment can maintain the porosity and acoustical absorption of the membrane. An example of the C-treatment is disclosed in U.S. Pat. No. 6,726,976, and is hereby incorporated by reference in its entirety.

In further embodiments, the outer surface of the ink-receptive layer can be an untreated surface. In the context of the outer surface of the ink-receptive layer, the term “untreated surface” indicates that the outer surface of the ink-receptive layer does not include a surface treatment. In particular embodiments, the ink-receptive layer does not include a corona treatment. In more particular embodiments, the ink-receptive layer does not include a C-treatment. In more particular embodiments, the ink-receptive layer does not include any of the treatments discussed above. Further, the printed layer can be applied to the untreated surface of the ink-receptive layer. That is to say, in certain embodiments, the printed layer can be directly adjacent the untreated surface of the ink-receptive layer.

As discussed above, the membrane can include a printed layer overlying the ink-receptive layer. The printed layer can include an ink comprising a vehicle and pigments or dyes to color the outer surface of the ink-receptive layer, such as to produce an image, text, or design. In certain embodiments, the ink can include a water-based ink or a solvent based ink. In particular embodiments, the ink can include a water-based ink. For example, the ink can include a latex ink, such as the HP 831 or HP LX610 latex inks, available from Hewlett Packard, which can be applied using an HP Latex 360 Printer. As used herein, the term “latex” refers to a stable, aqueous dispersion of polymer particles that form a durable film on the surface of a media to protect the pigments. The ink can have a degradation temperature of at most 270° C., or at most 265° C., or at most 260° C. The ink can have a degradation temperature of at least 210° C., or at least 215° C., or at least 220° C. The ink can have a degradation temperature in a range of 210 to 270° C., or 215 to 265° C., or 220 to 260° C. The degradation temperature refers to a temperature at which a color breakdown first occurs in the ink.

In certain embodiments, the printed layer can include a single color or multiple colors. Existing architectural membranes that meet building and fire codes are typically limited to a single uniform color as fluoropolymer surfaces, by nature, are difficult to print on. However, it is a particular advantage of certain embodiments described herein that the printed layer of the architectural membrane can include multiple colors and designs.

In certain embodiments, after the printed layer is applied, the membrane can undergo a post-printing thermal treatment. In certain embodiments, the thermal treatment can be performed inline with the printing operation. In particular embodiments, the thermal treatment can be provided via a conventional hot air oven, a belt laminator, an infrared heater, and the like. Without being limited by theory, it is believed that an aggressive thermal curing of the printed layer as described herein can improved ink adhesion. For example, it is believed that a chemical reaction can occur between the ink of the printed layer and the low-melt fluoropolymer can be initiated by the heat exposure and result in increased adhesion. In particular embodiments, thermally curing the printed layer can include curing at a temperature of at least 130° C. (266° F.), or at least 150° C. (300° F.), or at least 175° C. (350° F.), or at least 200° C. (400° F.), or at least 230° C. (450° F.). In further particular embodiments, the thermally curing can include curing at a temperature of no greater than 260° C. (500° F.), or no greater than 230° C. (450° F.), or no greater than 200° C. (400° F.), or no greater than 175° C. (350° F.). Moreover, thermally curing the printed layer can include curing at a temperature in a range of any of the above minimum and maximum values, such as 150 to 260° C., or 175 to 230° C., or 175 to 200° C., or 200 to 230° C., or 230 to 260° C.

As discussed above, the ink can have a degradation temperature at which a color breakdown occurs. Thus, to limit or prevent a breakdown in color, the thermal treatment can occur at a temperature near or below the degradation temperature. On the other hand, as discussed above, it can be advantageous to have a softening of the ink-receptive layer to increase adhesion of the printed layer to the ink-receptive layer. Accordingly, in certain embodiments, it can be advantageous to have the thermal treatment occur at a temperature between the melting temperature of the ink-receptive layer and the degradation temperature of the printed layer. In certain embodiments, when the thermal treatment occurs between the melting temperature of the ink-receptive layer and the degradation temperature of the printed layer, the ink-receptive layer can exhibit unexpectedly superior results in a Tape Peel Test.

It is a particular advantage of certain embodiments described herein that the membrane can exhibit improved printability and ink adhesion over existing technology. The ink adhesion of the membrane can be determined using the Tape Peel Test according to ASTM D3359 or JIS K5600-1999, each of which measures the percentage of ink removed. The less ink removed, the better the ink adhesion. In certain embodiments, the membrane can have an ink adhesion of no greater than 16% of ink removed, or no greater than 14% of ink removed, or no greater than 12% of ink removed, or even no greater than 10% of ink removed, according to ASTM D3359 or JIS K5600-1999. In other embodiments, the membrane can have an ink adhesion of 0% ink removed, or at least 1% ink removed, or even at least 2% ink removed, according to ASTM D3359 or JIS K5600-1999. Moreover, the membrane can have an ink adhesion in a range of any of the above minimum and maximum values, such as 0 to 16% ink removed, or 1 to 12% ink removed, or even 2 to 10% ink removed, according to ASTM D3359 or JIS K5600-1999.

In certain embodiments, the membrane can include a seam, such as a butt seam. It is a particular advantage of certain embodiments of the membrane described herein to engage in heat sealing, such as forming a seam, without degrading the ink of the printed layer. Further, it is a particular advantage of certain embodiments of the membrane described herein to exhibit improved seam strength. For example, the membrane can have a seam strength of at least 350 pli, or at least 375 pli, or at least 400 pli, or at least 425 pli, or even at least 450 pli. In other embodiments, the membrane can have a seam strength of no greater than 700 pli, or no greater than 650 pli, or no greater than 600 pli. Moreover, the membrane can have a seam strength in a range of any of the above minimum and maximum values, such as 350 to 700 pli, or 400 to 650 pli, or 450 to 600 pli. The seam strength can be measured according to ASTM D751. In certain embodiments, the seam can be a butt seam made by applying pressure with a heated platen to a temperature of about 400° F. for about 3 minutes to a layup of fabric which is comprised of a 3-5 mil THV film sandwiched between two layers of the coated fabric. Further, it is a particular advantage of certain embodiments of the membrane described herein to withstand heat sealing without degrading industry standard inks.

In certain embodiments the membrane can exhibit enhanced acoustical properties. For example the membrane can have a Noise Reduction Coefficient (NRC) of at least 0.5, or at least 0.6, or at least 0.7, or at least 0.8, or even at least 0.9. In other embodiments, the membrane can have a NRC of no greater than 1.0, or no greater than 0.9, or no greater than 0.8, or no greater than 0.7, or no greater than 0.6. Moreover, the membrane can have a NRC in a range of any of the above minimum and maximum values, such as 0.5 to 0.7, or 0.7 to 0.9, or 0.9 to 0.1.0. The NRC can be determined by ASTM C423-09a—Standard Test Method for Sound Absorption and Sound Absorption Coefficients by the Reverberation Room Method.

In certain embodiments, the membrane can exhibit improved air permeability. In an embodiment, the membrane can exhibit an air permeability of at least 8 cubic feet per minute per square foot (cfm/sq ft), or at least 9 cfm/sq ft, or at least 10 cfm/sq ft. In an embodiment, the membrane can exhibit an air permeability of most 35 cfm/sq ft, or at most 33 cfm/sq ft, or at most 31 cfm/sq ft. Moreover, the membrane can exhibit an air permeability in a range of any of the above values, such as 8 to 35 cfm/sq ft, or 9 to 33 cfm/sq ft, or 10 to 31 cfm/sq ft. The air permeability is measured according to ASTM D737-04(2016).

In an embodiment, the membrane can exhibit improved flame resistance. In a particular embodiment, the membrane can exhibit a Class A fire rating, as measured according to ASTM E84-16. The Class A fire rating includes a flame spread score of 0-25 and a smoke generation score between 0-450. In a particular embodiment, the membrane can receive a PASS, as measured according to ASTM E136-16, a standard test method for behavior of materials in a vertical tube furnace at 750° C., which reports a pass/fail score.

Furthermore, the membrane can be an architectural membrane. Certain embodiments of the architectural membrane can exhibit improved acoustical properties, improved fire resistance, improved adhesion strength and durability, or any combination thereof. Accordingly, the architectural membrane can be utilized as an interior ceiling structure, an acoustic wall panel, a vertical partition, as well as any other application where such properties are desirable.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. A membrane comprising: a reinforcement layer; an intermediate layer overlying the reinforcement layer, the intermediate layer comprising a blend including a fluoropolymer and a silicone; and an ink-receptive layer overlying the intermediate layer, the intermediate layer and the ink-receptive layer each having a melting temperature of no greater than 200° C.

Embodiment 2. A membrane comprising: a reinforcement layer; and an ink-receptive layer overlying the reinforcement layer, the ink-receptive layer having a melting temperature of no greater than 200° C., wherein the membrane exhibits at least one of: an ink adhesion of no greater than 10%, as measured using the Tape Peel Test according to JIS K5600-1999; a Class A fire rating, as measured according to ASTM E84-16; and a Noise Reduction Coefficient (NRC) of at least 0.5, as measured according to ASTM C423-09a.

Embodiment 3. A method of making a coated fabric, the method comprising: providing a reinforcement layer and an ink-receptive layer overlying the reinforcement layer, wherein the ink-receptive layer has a melting temperature of no greater than 200° C.; disposing a printed layer on the low-melt ink-receptive layer; and thermally curing the printed layer.

Embodiment 4. A method of making a coated fabric, the method comprising: providing a reinforcement layer and a low-melt ink-receptive layer overlying the reinforcement layer, wherein the ink-receptive layer has a melt temperature of no greater than 200° C.; and rendering the low-melt ink-receptive layer bondable via a C-treatment.

Embodiment 5. The membrane or method of any one of embodiments 2 to 4, further comprising an intermediate layer disposed between the reinforcement layer and the ink-receptive layer.

Embodiment 6. The membrane or method of any one of embodiments 1, 2, 4, and 5, further comprising a printed layer overlying the low-melt ink-receptive layer

Embodiment 7. The membrane or method of any one of the preceding embodiments, wherein the intermediate, ink-receptive layer, or both, has a melting temperature of no greater than 195° C., or no greater than 190° C., or no greater than 185° C., or no greater than 180° C.

Embodiment 8. The membrane or method of any one of the preceding embodiments, wherein the low-melt ink-receptive layer has a melting temperature of at least 80° C., or at least 85° C., or at least 90° C., or at least 95° C., or at least 100° C.

Embodiment 9. The membrane or method of any one of the preceding embodiments, wherein the low-melt ink-receptive layer has a melting temperature in a range of 80 to 200° C., or 85 to 195° C., or 90 to 190° C., or 95 to 185° C., or 100 to 180° C.

Embodiment 10. The membrane or method of any one of the preceding embodiments, wherein the ink-receptive layer includes a fluoropolymer.

Embodiment 11. The membrane or method of any one of the preceding embodiments, wherein the ink-receptive layer includes a tetrafluoroethylene-co-hexafluoropropylene-co-vinylidene fluoride terpolymer (hereinafter “THV”), a terpolymer of ethylene, tetrafluoroethylene, and hexafluoropropylene (hereinafter “EFEP”), a polyvinylidene difluoride (hereinafter “PVDF”), or any combination thereof.

Embodiment 12. The membrane or method of any one of the preceding embodiments, wherein the low-melt ink-receptive layer includes a THV polymer.

Embodiment 13. The membrane or method of any one of embodiments 11 and 12, wherein the low-melt ink-receptive layer further comprises a polytetrafluoroethylene (hereinafter “PTFE”), a perfluoroalkylvinyl ether (hereinafter “PFA”), a polyhexafluoropropylene (hereinafter “HFP”), a fluorinated ethylene-propylene copolymer (hereinafter “FEP”), an ethylene tetrafluoroethylene copolymer (hereinafter “ETFE”), a polychlorotrifluoroethylene (hereinafter “PCTFE”), a perfluoropropylene-vinyl-ether (hereinafter “PPVE”), a copolymer of PTFE and PPVE (hereinafter “TFM”), or any combination thereof.

Embodiment 14. The membrane or method of any one of the preceding embodiments, wherein the low-melt ink-receptive has a thickness of at least 0.01 mm, or at least 0.02 mm, or at least 0.03 mm, or at least 0.04 mm, or at least 0.05 mm.

Embodiment 15. The membrane or method of any one of the preceding embodiments, wherein the low-melt ink-receptive has a thickness of no greater than 1 mm, or no greater than 0.8 mm, or no greater than 0.6 mm, or no greater than 0.4 mm, or no greater than 0.2 mm, or no greater than 0.1 mm.

Embodiment 16. The membrane or method of any one of the preceding embodiments, wherein the low-melt ink-receptive has a thickness in range of 0.01 to 1 mm, or 0.03 to 0.6 mm, or even 0.05 to 0.1 mm.

Embodiment 17. The membrane or method of any one of embodiments 1 and 5 to 16, wherein the intermediate layer includes a fluoropolymer and a silicone.

Embodiment 18. The membrane or method of any one of embodiments 1 and 5 to 17, wherein the intermediate layer includes a fluoropolymer and a silicone oil.

Embodiment 19. The membrane or method of any one of the preceding embodiments, wherein the intermediate layer includes a fluoropolymer and the fluoropolymer includes a tetrafluoroethylene-co-hexafluoropropylene-co-vinylidene fluoride terpolymer (hereinafter “THV”), a terpolymer of ethylene, tetrafluoroethylene, and hexafluoropropylene (hereinafter “EFEP”), a polyvinylidene difluoride (hereinafter “PVDF”), or any combination thereof.

Embodiment 20. The membrane or method of any one of embodiments 1 and 5 to 19, wherein the intermediate layer includes a fluoropolymer and a silicone, and the fluoropolymer includes a THV polymer.

Embodiment 21. The membrane or method of any one of embodiments 17 to 20, wherein the intermediate layer further comprises a polytetrafluoroethylene (hereinafter “PTFE”), a perfluoroalkylvinyl ether (hereinafter “PFA”), a polyhexafluoropropylene (hereinafter “HFP”), a fluorinated ethylene-propylene copolymer (hereinafter “FEP”), an ethylene tetrafluoroethylene copolymer (hereinafter “ETFE”), a polychlorotrifluoroethylene (hereinafter “PCTFE”), a perfluoropropylene-vinyl-ether (hereinafter “PPVE”), a copolymer of PTFE and PPVE (hereinafter “TFM”), or any combination thereof.

Embodiment 22. The membrane or method of any one of the preceding embodiments, wherein the membrane has a coating adhesion of at least 10 pli, or at least 12 pli, or at least 14 pli, or at least 16 pli, as measured according to the standard T-Peel test of ASTM D751-06, using a 3 mil THV film as glue line.

Embodiment 23. The membrane or method of any one of the preceding embodiments, wherein the membrane has a coating adhesion of no greater than 30 pli, or no greater than 28 pli, or no greater than 26 pli, or no greater than 24 pli, or no greater than 22 pli, or even no greater than 20 pli, as measured according to the standard T-Peel test of ASTM D751-06, using a 3 mil THV film as glue line.

Embodiment 24. The membrane or method of any one of the preceding embodiments, wherein the membrane has a coating adhesion in a range of 10 to 30 pli, or 14 to 22 pli, or even 16 to 20 pli, as measured according to the standard T-Peel test of ASTM D751-06, using a 3 mil THV film as glue line.

Embodiment 25. The membrane or method of any one of embodiments 2, 3, and 5 to 24, wherein an outer surface of the ink-receptive layer includes a C-treatment.

Embodiment 26. The membrane or method of any one of embodiments 1 to 3 and 5 to 25, wherein an outer surface of the ink-receptive layer is an untreated surface, free of a corona treatment or a C-treatment.

Embodiment 27. The membrane or method of any one of embodiments 3 and 6 to 26, wherein the printed layer comprises an ink.

Embodiment 28. The membrane or method of any one of embodiments 3 and 6 to 27, wherein the printed layer comprises an water-based ink.

Embodiment 29. The membrane or method of any one of embodiments 3 and 6 to 28, wherein the printed layer comprises a latex ink.

Embodiment 30. The membrane or method of any one of embodiments 3 and 6 to 29, wherein the printed layer comprises a plurality of colors, designs, or both.

Embodiment 31. The membrane or method of any one of embodiments 27 to 30, wherein the membrane is heat sealable without degrading the ink of the printed layer.

Embodiment 32. The method of any one of embodiments 4 to 31, further comprising thermally curing the printed layer.

Embodiment 33. The method of any one of embodiments 3 to 11, wherein thermally curing the printed layer includes curing at a temperature of at least 130° C., or at least 150° C., or at least 175° C., or at least 200° C.

Embodiment 34. The method of any one of embodiments 3 to 12, wherein thermally curing the printed layer includes curing at a temperature of no greater than 260° C., or no greater than 230° C.

Embodiment 35. The method of any one of embodiments 3 and 31 to 34, wherein thermally curing the printed layer includes curing at a temperature in a range of 150 to 260° C., or 175 to 230° C., or 175 to 200° C., or 200 to 230° C., or 230 to 260° C.

Embodiment 36. The membrane or method of any one of embodiments 3 to 12, wherein the printed layer has an ink adhesion of no greater than 16% of ink removed, or no greater than 14% of ink removed, or no greater than 12% of ink removed, or even no greater than 10% of ink removed, as measured using the Tape Peel Test according to ASTM D3359 or JIS K5600-1999.

Embodiment 37. The membrane or method of any one of embodiments 3 and 6 to 36, wherein the printed layer has an ink adhesion of 0% ink removed, or at least 1% ink removed, or even at least 2% ink removed, as measured using the Tape Peel Test according to ASTM D3359.

Embodiment 38. The membrane or method of any one of embodiments 3 and 6 to 37, wherein the printed layer has an ink adhesion in a range of 0 to 16% ink removed, or 1 to 12% ink removed, or even 2 to 10% ink removed, as measured using the Tape Peel Test according to ASTM D3359.

Embodiment 39. The membrane or method of any one of the preceding embodiments, wherein the membrane includes a seam.

Embodiment 40. The membrane or method of embodiment 39, wherein the seam has a seam strength of at least 350 pli, or at least 375 pli, or at least 400 pli, or at least 425 pli, or even at least 450 pli, as measured according to ASTM D751.

Embodiment 41. The membrane or method of any one of embodiments 39 and 40, wherein the seam has a seam strength of no greater than 700 pli, or no greater than 650 pli, or no greater than 600 pli, as measured according to ASTM D751.

Embodiment 42. The membrane or method of any one of embodiments 39 to 41, wherein the seam has a seam strength in a range of 350 to 700 pli, or 400 to 650 pli, or 450 to 600 pli, as measured according to ASTM D751.

Embodiment 43. The membrane or method of any one of the preceding embodiments, wherein the membrane has a Noise Reduction Coefficient (NRC) of at least 0.5, or at least 0.6, or at least 0.7, or at least 0.8, or even at least 0.9, as measured according to ASTM C423-09a.

Embodiment 44. The membrane or method of any one of the preceding embodiments, wherein the membrane has a Noise Reduction Coefficient (NRC) of no greater than 1.0, or no greater than 0.9, or no greater than 0.8, or no greater than 0.7, or no greater than 0.6, as measured according to ASTM C423-09a.

Embodiment 45. The membrane or method of any one of the preceding embodiments, wherein the membrane has a Noise Reduction Coefficient (NRC) in a range of 0.5 to 0.7, or 0.7 to 0.9, or 0.9 to 0.1.0, as measured according to ASTM C423-09a.

Embodiment 46. The membrane or method of any one of the preceding embodiments, wherein the membrane includes an architectural membrane.

Embodiment 47. The membrane or method of embodiment 46, wherein the architectural membrane includes an interior ceiling structure, an acoustic wall panel, or a vertical partition.

The concepts described herein will be further described in the following examples, which do not limit the scope of the invention described in the claims. Numerical values in this Examples section may be approximated or rounded off for convenience.

### EXAMPLES

Samples 1 and 2 were made using a plain weave glass fabric, having a thickness of 14 mils and a weight of 8.8 oz/yd² with a yarn warp of BC 150 2/2 and a yarn filling of BC 150 2/2, woven to a warp and fill count of 32 by 23, that was initially dip coated with a THV fluoropolymer. This material was then dip coated again with THV resulting in a THV fluropolymer surface. The samples did not have any surface treatments and the finished material still possessed a measureable degree of porosity.

The coating adhesion of Sample 1 was evaluated by seaming two pieces of the coated fabric to one another using a 3 mil THV film as the glue line between the fabric pieces. Seaming itself was accomplished by subjecting the layup to 400° F. for a duration of 3 minutes. The coating adhesion of Sample 1 was found to be 16.0 lbf/inch as measured by a standard T-Peel test according to ASTM D751—Test Methods for Coated Fabrics.

In addition, Samples 1 and 2 were printed on using an HP Latex 360 printer utilizing HP 831 series inks. The level of ink adhesion on Sample 1 was first assessed without further processing by way of a tape peel test as described in ASTM D3359. This test showed greater than 50% of ink being removed from the fabric surface. The tape peel test was then repeated on Sample 2 after it had been exposed to a temperature of 400° F. for a duration of 2 minutes in a hot air oven. The tape peel test on Sample 2 showed less than 5% of ink being removed from the surface.

Samples 3 to 12 were prepared similar to Samples 1 and 2 without a surface treatment on the ink-receptive layer. Each of Samples 3 to 12 received an identical printed layer and then was subjected to a thermal treatment at different temperatures and for different periods. The printed samples were then subjected to a standard Tape Peel Test according to JIS K5600-1999 (Testing methods for paints, Part 5: Mechanical property of film, Section 6: Adhesion test). The temperature and period for each thermal treatment and the results for each adhesion test is provided below in Table 1.

TABLE 1

| | Thermal Treatment | | Tape Peel Test |
|---|---|---|---|
| Sample | Temperature (° C.) | Time (seconds) | % Ink Peel |
| 3 | 115 | 120 | greater than 50% |
| 4 | 143 | 120 | between 10 and 50% |
| 5 | 143 | 300 | less than 10% |
| 6 | 149 | 120 | less than 10% |
| 7 | 171 | 30 | 0% |
| 8 | 171 | 60 | 0% |
| 9 | 171 | 120 | 0% |
| 10 | 193 | 30 | 0% |
| 11 | 193 | 60 | 0% |
| 12 | 193 | 120 | 0% |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A membrane comprising:
a reinforcement layer;
an intermediate layer overlying the reinforcement layer, the intermediate layer comprising a blend including a first fluoropolymer and a silicone; and
an ink-receptive layer overlying the intermediate layer, the ink-receptive layer comprising a second fluoropolymer;
wherein the first fluoropolymer and the second fluoropolymer each have a melting temperature of no greater than 200° C.

2. A membrane comprising:
a reinforcement layer; and
an ink-receptive layer overlying the reinforcement layer;
wherein the ink-receptive layer comprises a fluoropolymer,
wherein the fluoropolymer has a melting temperature of no greater than 200° C., and
wherein the membrane exhibits an ink removal of no greater than 10%, as measured using the Tape Peel Test according to JIS K5600-1999.

3. The membrane of claim 2, wherein the membrane further comprises a printed layer overlying the ink-receptive layer.

4. The membrane of claim 3, wherein the printed layer comprises an ink, and wherein the printed layer has an ink adhesion of no greater than 16% of ink removed, as measured using the Tape Peel Test according to ASTM D3359.

5. The membrane of claim 3, wherein the printed layer comprises an ink, and wherein the ink has a degradation temperature of at most 270° C.

6. The membrane of claim 2, wherein the fluoropolymer of the intermediate layer and the fluoropolymer of the ink-receptive layer each have a melting temperature of no greater than 195° C.

7. The membrane of claim 2, wherein the ink-receptive layer includes a tetrafluoroethylene-co-hexafluoropropylene-co-vinylidene fluoride terpolymer (“THV”); a terpolymer of ethylene, tetrafluoroethylene, and hexafluoropropylene (“EFEP”); or a polyvinylidene difluoride (“PVDF”).

8. The membrane of claim 2, wherein the ink-receptive layer includes a THV polymer.

9. The membrane of claim 2, wherein the intermediate layer includes a fluoropolymer and the fluoropolymer includes a tetrafluoroethylene-co-hexafluoropropylene-co-vinylidene fluoride terpolymer (“THV”); a terpolymer of ethylene, tetrafluoroethylene, and hexafluoropropylene (“EFEP”); a polyvinylidene difluoride (“PVDF”); or any combination thereof.

10. The membrane of claim 9, wherein the intermediate layer includes a polytetrafluoroethylene (“PTFE”); a perfluoroalkylvinyl ether (“PFA”), a polyhexafluoropropylene (“HFP”); a fluorinated ethylene-propylene copolymer (“FEP”); an ethylene tetrafluoroethylene copolymer (“ETFE”); a polychlorotrifluoroethylene (“PCTFE”); a perfluoropropylene-vinyl-ether (“PPVE”); or a copolymer of PTFE and PPVE (“TFM”).

11. The membrane of claim 2, wherein the membrane has a coating adhesion of at least 10 pounds per linear inch, as measured according to the standard T-Peel test of ASTM D751-06, using a 3 mil THV film as glue line.

12. The membrane of claim 2, wherein the membrane has an air permeability of at least 8 cubic feet per minute per square foot.

13. The membrane of claim 2, wherein the membrane has an air permeability of at most 35 cubic feet per minute per square foot.

14. The membrane of claim 2, wherein the membrane has a Noise Reduction Coefficient (NRC) of at least 0.5, as measured according to ASTM C423-09a.

15. The membrane of claim 2, wherein the membrane has a Class A fire rating, as measured according to ASTM E84-16;

16. The membrane of claim 2, wherein the membrane includes an architectural membrane.

17. The membrane of claim 16, wherein the architectural membrane includes an interior ceiling structure, an acoustic wall panel, or a vertical partition.

18. A method of making a coated fabric, the method comprising:
disposing an ink-receptive layer overlying a reinforcement layer, wherein the ink-receptive layer comprises a fluoropolymer, and the fluoropolymer has a melting temperature of no greater than 200° C.;
disposing a printed layer on the ink-receptive layer; and
thermally curing the printed layer.

19. The method of claim 18, wherein thermally curing the printed layer includes curing at a temperature of at least 130° C.

20. The method of claim 18, wherein thermally curing the printed layer includes curing at a temperature of no greater than 260° C.
